(19) United States
(12) Patent Application Publication
(10) Pub. No.: US 2013/0089332 A1
(43) Pub. Date: Apr. 11, 2013

(54) OPTICAL FIBER-BASED DISTRIBUTED COMMUNICATIONS COMPONENTS, SYSTEMS, AND METHODS EMPLOYING WAVELENGTH DIVISION MULTIPLEXING (WDM) FOR ENHANCED UPGRADABILITY

(71) Applicants: Michael Sauer, Corning, NY (US); Wolfgang Gottfried Tobias Schweiker, Weyarn (DE)

(72) Inventors: Michael Sauer, Corning, NY (US); Wolfgang Gottfried Tobias Schweiker, Weyarn (DE)

(21) Appl. No.: 13/688,448

(22) Filed: Nov. 29, 2012

Related U.S. Application Data
(63) Continuation of application No. PCT/US10/37377, filed on Jun. 4, 2010.

(51) Int. Cl. H04J 14/02

(52) U.S. Cl. CPC H04J 14/0278
USPC 398/72

(57) ABSTRACT

Optical fiber-based distributed communications components and systems employing wavelength division multiplexing (WDM) for enhanced upgradability. The system comprises a plurality of downlink optical transmitters configured to receive downlink electrical radio frequency (RF) signals from a plurality of RF sources and convert the downlink electrical RF signals into downlink optical RF signals. The system also has a wavelength division multiplexer configured to multiplex downlink optical RF signals into a plurality of downlink wavelengths over a common downlink optical fiber connected to a plurality of remote antenna units (RAUs). In this manner, additional downlink optical fibers are not required to support providing additional RAUs in the system. Wavelength-division de-multiplexing can avoid providing additional uplink optical fibers to distribute uplink signals to RAUs added in the system.

### RELATED APPLICATIONS

This application is a continuation of International Patent Application Serial No. PCT/US10/37377 filed on Jun. 4, 2010, the content of which is relied upon and incorporated herein by reference in its entirety.

### BACKGROUND

1. Field of the Disclosure

The technology of the disclosure relates to optical fiber-based distributed communications systems for distributing radio frequency (RF) signals over optical fiber to remote antenna units, and related control systems and methods.

2. Technical Background

Wireless communication is rapidly growing, with ever-increasing demands for high-speed mobile data communication. As an example, so-called “wireless fidelity” or “WiFi” systems and wireless local area networks (WLANs) are being deployed in many different types of areas (e.g., coffee shops, airports, libraries, etc.). Distributed communications systems communicate with wireless devices called “clients,” which must reside within the wireless range or “cell coverage area” in order to communicate with an access point device.

One approach to deploying a distributed communications system involves the use of radio frequency (RF) antenna coverage areas, also referred to as “antenna coverage areas.” Antenna coverage areas can have a radius in the range from a few meters up to twenty meters as an example. Combining a number of access point devices creates an array of antenna coverage areas. Because the antenna coverage areas each cover small areas, there are typically only a few users (clients) per antenna coverage area. This allows for minimizing the amount of RF bandwidth shared among the wireless system users. It may be desirable to provide antenna coverage areas in a building or other facility to provide distributed communications system access to clients within the building or facility. However, it may be desirable to employ optical fiber to distribute communication signals. Benefits of optical fiber include increased bandwidth.

One type of distributed communications system for creating antenna coverage areas, called “Radio-over-Fiber” or “RoF,” utilizes RF signals sent over optical fibers. Such systems can include a head-end station optically coupled to a plurality of remote antenna units that each provides antenna coverage areas. The remote antenna units can each include RF transceivers coupled to an antenna to transmit RF signals wirelessly, wherein the remote antenna units are coupled to the head-end station via optical fiber links. The RF transceivers in the remote antenna units are transparent to the RF signals. The remote antenna units convert incoming optical RF signals from an optical fiber downlink to electrical RF signals via optical-to-electrical (O/E) converters, which are then passed to the RF transceiver. The RF transceiver converts the electrical RF signals to electromagnetic signals via antennas coupled to the RF transceiver provided in the remote antenna units. The antennas also receive electromagnetic signals (i.e., electromagnetic radiation) from clients in the antenna coverage area and convert them to electrical RF signals (i.e., electrical RF signals in wire). The remote antenna units then convert the electrical RF signals to optical RF signals via electrical-to-optical (E/O) converters. The optical RF signals are then sent over an optical fiber uplink to the head-end station.

In this example, distinct downlink and uplink optical fibers support each remote antenna unit provided in the distributed communications system. A fiber optic cable containing multiple downlink and uplink optical fiber pairs may be provided to support multiple remote antenna units from the fiber optic cable. Thus, the number of optical fibers provided in a fiber optic cable controls the maximum number of remote antenna units that can be supported by a given fiber optic cable in this example. It may be desirable to provide additional remote antenna units to support additional antenna coverage areas in the distributed communications system after initial installation. However, if an installed fiber optic cable is already supporting a maximum number of remote antenna units, additional remote antenna units cannot be supported by the fiber optic cable. One solution to alleviate this issue is to install additional “dark” optical fibers in the distributed communications system during initial installation. Additional remote antenna units can be connected to the “dark” optical fibers after initial installation to provide additional antenna coverage areas. However, installing “dark” optical fibers adds additional upfront costs in terms of providing additional, initially unused optical fibers and labor costs to install. Alternatively, to avoid installation of “dark” optical fibers, new optical fibers could be installed when adding remote antenna units to the distributed communications system. However, it may be more expensive to add new optical fibers after initial installation and is also time consuming.

### SUMMARY OF THE DETAILED DESCRIPTION

Embodiments disclosed in the detailed description include optical fiber-based distributed communications components and systems, and related methods employing wavelength division multiplexing (WDM) for enhanced upgradability. In one embodiment, an optical fiber-based distributed communications system is provided. The system comprises a plurality of downlink optical transmitters configured to receive downlink electrical radio frequency (RF) signals from a plurality of RF sources and convert the downlink electrical RF signals into downlink optical RF signals. The system also comprises a wavelength division multiplexer configured to multiplex the downlink optical RF signals into a plurality of downlink wavelengths over a common downlink optical fiber configured to be connected to a plurality of remote antenna units (RAUs). In this manner, additional downlink optical fibers are not required to be installed or “dark” downlink optical fibers employed, as examples, to support providing additional RAUs in the system. Additional RAUs can be added to the system by connecting the additional RAUs to the common downlink optical fiber in a daisy-chain configuration, for example, if desired.

In another embodiment, a method of distributing communication signals in an optical fiber-based distributed communications system is provided. The method comprises receiving downlink electrical radio frequency (RF) signals from a plurality of RF sources. The method also comprises wavelength division multiplexing the downlink optical RF signals into a plurality of downlink wavelengths over a common downlink optical fiber. In this manner, additional downlink optical fibers are not required to be installed or “dark” downlink optical fibers employed, as examples, to distribute downlink optical signals to RAUs added in the system.

The systems and methods disclosed in the detailed description can also include wavelength-division de-multiplexing. For example, the systems could include a wavelength-division de-multiplexer configured to receive uplink optical RF signals from a plurality of RAUs on a common uplink optical fiber, and de-multiplex a plurality of uplink wavelengths from the uplink optical RF signals into separate wavelengths on separate optical fibers. In this manner, additional uplink optical fibers are not required to be installed or “dark” uplink optical fibers employed, as examples, to distribute uplink optical signals to RAUs added in the system.

Additional features and advantages will be set forth in the detailed description which follows, and in part will be readily apparent to those skilled in the art from that description or recognized by practicing the embodiments as described herein, including the detailed description that follows, the claims, as well as the appended drawings.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE FIGURES

FIG. 1 is a schematic diagram of an exemplary optical fiber-based distributed communications system;

FIG. 2 is a more detailed schematic diagram of an exemplary head-end unit (HEU) and a remote antenna unit (RAU) deployed in the optical fiber-based distributed communications system of FIG. 1;

FIG. 3 is a partially schematic cut-away diagram of an exemplary building infrastructure in which an optical fiber-based distributed communications system can be employed;

FIG. 4 is a schematic diagram of employing wavelength division multiplexing (WDM) in an optical-fiber based distributed communications system to allow additional RAUs to be supported in a daisy-chain configuration;

FIG. 5 is a schematic diagram of employing WDM to multiplex a plurality of downlink optical RF signals from a plurality of transmit optical subassemblies (TOSAs) at different wavelengths over a common downlink optical fiber for an optical-fiber based distributed communications system;

FIG. 6 is a schematic diagram of employing wavelength division de-multiplexing (WDD) to de-multiplex a plurality of uplink optical RF signals from a plurality of TOSAs in RAUs at different wavelengths over a common uplink optical fiber for an optical-fiber based distributed communications system;

FIG. 7 is a schematic diagram of the exemplary HEU employing WDM on a common downlink optical fiber and WDD on a common uplink optical fiber for an RAU, as provided FIGS. 5 and 6, respectively;

FIG. 8 is a schematic diagram of another exemplary HEU that can employ WDM on a common downlink optical fiber and WDD on a common uplink optical fiber for an RAU, as provided FIGS. 5 and 6, respectively;

FIG. 9 is a schematic diagram of FIG. 5, but alternatively employing a common modulator on the downlink optical fiber in lieu of providing individual modulators disposed in each downlink TOSA;

FIG. 10 is a schematic diagram of FIG. 6, but alternatively employing a common receiver optical subassembly (ROSA) on the uplink optical fiber in lieu of providing individual uplink ROSAs; and

FIG. 11 is a schematic diagram of exemplary RAUs connected to an HEU and involved in a four-by-four (4×4) Multiple Input/Multiple Output (MIMO) communication processing scheme.

### DETAILED DESCRIPTION

Reference will now be made in detail to the embodiments, examples of which are illustrated in the accompanying drawings, in which some, but not all embodiments are shown. Indeed, the concepts may be embodied in many different forms and should not be construed as limiting herein; rather, these embodiments are provided so that this disclosure will satisfy applicable legal requirements. Whenever possible, like reference numbers will be used to refer to like components or parts.

Embodiments disclosed in the detailed description include optical fiber-based distributed communications components and systems, and related methods employing wavelength division multiplexing (WDM) for enhanced upgradability. In one embodiment, an optical fiber-based distributed communications system is provided. The system comprises a plurality of downlink optical transmitters configured to receive downlink electrical radio frequency (RF) signals from a plurality of RF sources and convert the downlink electrical RF signals into downlink optical RF signals. The system also comprises a wavelength division multiplexer configured to multiplex the downlink optical RF signals into a plurality of downlink wavelengths over a common downlink optical fiber configured to be connected to a plurality of remote antenna units (RAUs). In this manner, additional downlink optical fibers are not required to be installed or “dark” downlink optical fibers employed, as examples, to support providing additional RAUs in the system. Additional RAUs can be added to the system by connecting the additional RAUs to the common downlink optical fiber in a daisy-chain configuration, for example, if desired.

The systems and methods disclosed in the detailed description can also include wavelength-division de-multiplexing. For example, the systems could include a wavelength-division de-multiplexer configured to receive uplink optical RF signals from a plurality of RAUs on a common uplink optical fiber, and de-multiplex a plurality of uplink wavelengths from the uplink optical RF signals into separate wavelengths on separate optical fibers. In this manner, additional uplink optical fibers are not required to be installed or “dark” uplink optical fibers employed, as examples, to distribute uplink optical signals to RAUs added in the system.

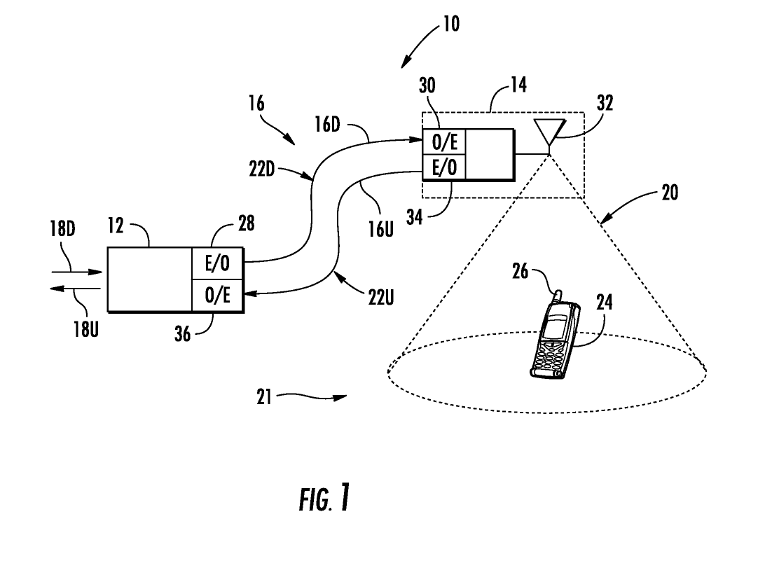

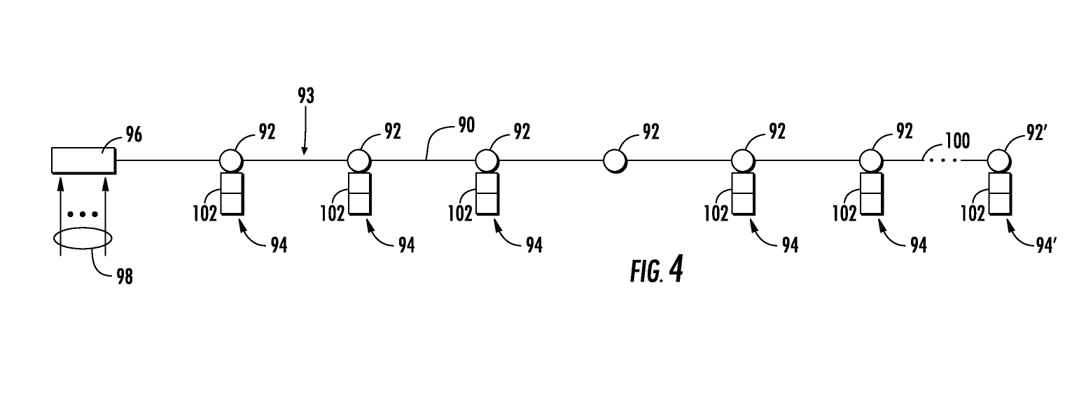

Before discussing the exemplary components, systems, and methods of employing wavelength division multiplexing (WDM) and/or wavelength division de-multiplexing (WDD) for enhanced upgradability in optical fiber-based distributed communications systems, the description of which starts at FIG. 4, an exemplary generalized optical fiber-based distributed communications system is first described with regard to FIGS. 1-3.

In this regard, FIG. 1 is a schematic diagram of a generalized embodiment of an optical fiber-based distributed communications system. In this embodiment, the system is an optical fiber-based distributed communications system 10 that is configured to create one or more antenna coverage areas for establishing communications with wireless client devices located in the radio frequency (RF) range of the antenna coverage areas. In this embodiment, the optical fiber-based distributed communications system 10 includes a head-end unit (HEU) 12, one or more remote antenna units (RAUs) 14, and an optical fiber 16 that optically couples the HEU 12 to the RAU 14. The HEU 12 is configured to receive communications over downlink electrical RF signals 18D from a source or sources, such as a network or carrier as examples, and provide such communications to the RAU 14. The HEU 12 is also configured to return communications received from the RAU 14, via uplink electrical RF signals 18U, back to the source or sources. In this regard in this embodiment, the optical fiber 16 includes at least one downlink optical fiber 16D to carry signals communicated from the HEU 12 to the RAU 14 and at least one uplink optical fiber 16U to carry signals communicated from the RAU 14 back to the HEU 12.

The optical fiber-based distributed communications system 10 has an antenna coverage area 20 that can be substantially centered about the RAU 14. The antenna coverage area 20 of the RAU 14 forms an RF coverage area 21. The HEU 12 is adapted to perform or to facilitate any one of a number of Radio-over-Fiber (RoF) applications, such as radio frequency (RF) identification (RFID), wireless local-area network (WLAN) communication, or cellular phone service. Shown within the antenna coverage area 20 is a client device 24 in the form of a mobile device as an example, which may be a cellular telephone as an example. The client device 24 can be any device that is capable of receiving RF communication signals. The client device 24 includes an antenna 26 (e.g., a wireless card) adapted to receive and/or send electromagnetic RF signals.

With continuing reference to FIG. 1, to communicate the electrical RF signals over the downlink optical fiber 16D to the RAU 14, to in turn be communicated to the client device 24 in the antenna coverage area 20 formed by the RAU 14, the HEU 12 includes an electrical-to-optical (E/O) converter 28. The E/O converter 28 converts the downlink electrical RF signals 18D to downlink optical RF signals 22D to be communicated over the downlink optical fiber 16D. The RAU 14 includes an optical-to-electrical (O/E) converter 30 to convert received downlink optical RF signals 22D back to electrical RF signals to be communicated wirelessly through an antenna 32 of the RAU 14 to client devices 24 located in the antenna coverage area 20.

Similarly, the antenna 32 is also configured to receive wireless RF communications from client devices 24 in the antenna coverage area 20. In this regard, the antenna 32 receives wireless RF communications from client devices 24 and communicates electrical RF signals representing the wireless RF communications to an E/O converter 34 in the RAU 14. The E/O converter 34 converts the electrical RF signals into uplink optical RF signals 22U to be communicated over the uplink optical fiber 16U. An O/E converter 36 provided in the HEU 12 converts the uplink optical RF signals 22U into uplink electrical RF signals, which can then be communicated as uplink electrical RF signals 18U back to a network or other source.

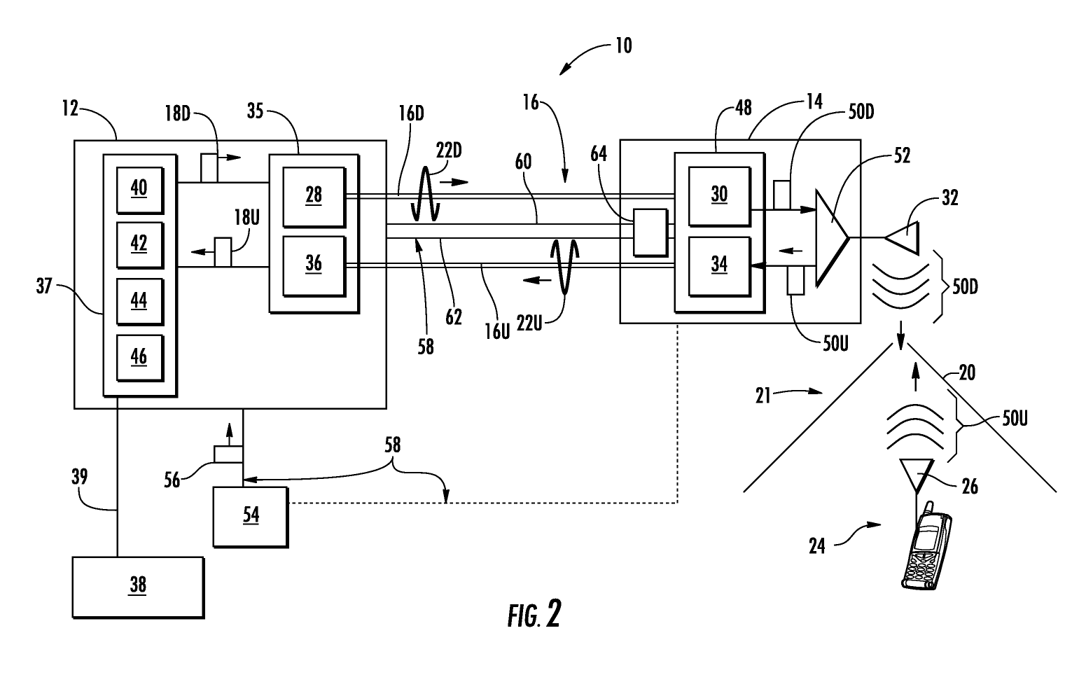

FIG. 2 is a more detailed schematic diagram of the exemplary optical fiber-based distributed communications system of FIG. 1 that provides electrical RF service signals for a particular RF service or application. In an exemplary embodiment, the HEU 12 includes a service unit 37 that provides electrical RF service signals by passing (or conditioning and then passing) such signals from one or more outside networks 38 via a network link 39. In a particular example embodiment, this includes providing WLAN signal distribution as specified in the Institute of Electrical and Electronics Engineers (IEEE) 802.11 standard, i.e., in the frequency range from 2.4 to 2.5 GigaHertz (GHz) and from 5.0 to 6.0 GHz. Any other electrical RF signal frequencies are possible. In another exemplary embodiment, the service unit 37 provides electrical RF service signals by generating the signals directly. In another exemplary embodiment, the service unit 37 coordinates the delivery of the electrical RF service signals between client devices 24 within the antenna coverage area 20.

With continuing reference to FIG. 2, the service unit 37 is electrically coupled to the E/O converter 28 that receives the downlink electrical RF signals 18D from the service unit 37 and converts them to corresponding downlink optical RF signals 22D. In an exemplary embodiment, the E/O converter 28 includes a laser suitable for delivering sufficient dynamic range for the RoF applications described herein, and optionally includes a laser driver/amplifier electrically coupled to the laser. Examples of suitable lasers for the E/O converter 28 include, but are not limited to, laser diodes in the form of distributed feedback (DFB) lasers, Fabry-Perot (FP) lasers, and vertical cavity surface emitting lasers (VCSELs).

With continuing reference to FIG. 2, the HEU 12 also includes the O/E converter 36, which is electrically coupled to the service unit 37. The O/E converter 36 receives the uplink optical RF signals 22U and converts them to corresponding uplink electrical RF signals 18U. In an example embodiment, the O/E converter 36 is a photodetector, or a photodetector electrically coupled to a linear amplifier. The E/O converter 28 and the O/E converter 36 constitute a “converter pair” 35, as illustrated in FIG. 2.

In accordance with an exemplary embodiment, the service unit 37 in the HEU 12 can include an RF signal modulator/demodulator unit 40 for modulating/demodulating the downlink electrical RF signals 18D and the uplink electrical RF signals 18U, respectively. The service unit 37 can include a digital signal processing unit (“digital signal processor”) 42 for providing to the RF signal modulator/demodulator unit 40 an electrical signal that is modulated onto an RF carrier to generate a desired downlink electrical RF signal 18D. The digital signal processor 42 is also configured to process a demodulation signal provided by the demodulation of the uplink electrical RF signal 18U by the RF signal modulator/demodulator unit 40. The HEU 12 can also include an optional central processing unit (CPU) 44 for processing data and otherwise performing logic and computing operations, and a memory unit 46 for storing data, such as data to be transmitted over a WLAN or other network for example.

With continuing reference to FIG. 2, the RAU 14 also includes a converter pair 48 comprising the O/E converter 30 and the E/O converter 34. The O/E converter 30 converts the received downlink optical RF signals 22D from the HEU 12 back into downlink electrical RF signals 50D. The E/O converter 34 converts uplink electrical RF signals 50U received from the client device 24 into the uplink optical RF signals 22U to be communicated to the HEU 12. The O/E converter 30 and the E/O converter 34 are electrically coupled to the antenna 32 via an RF signal-directing element 52, such as a circulator for example. The RF signal-directing element 52 serves to direct the downlink electrical RF signals 50D and the uplink electrical RF signals 50U, as discussed below. In accordance with an exemplary embodiment, the antenna 32 can include one or more patch antennas, such as disclosed in U.S. patent application Ser. No. 11/504,999, filed Aug. 16, 2006 entitled “Radio-over-Fiber Transponder With a Dual-band Patch Antenna System,” and U.S. patent application Ser. No. 11/451,553, filed Jun. 12, 2006 entitled “Centralized Optical Fiber-based Wireless Picocellular Systems and Methods,” both of which are incorporated herein by reference in their entireties.

With continuing reference to FIG. 2, the optical fiber-based distributed communications system 10 also includes a power supply 54 that generates an electrical power signal 56. The power supply 54 is electrically coupled to the HEU 12 for powering the power-consuming elements therein. In an exemplary embodiment, an electrical power line 58 runs through the HEU 12 and over to the RAU 14 to power the O/E converter 30 and the E/O converter 34 in the converter pair 48, the optional RF signal-directing element 52 (unless the RF signal-directing element 52 is a passive device such as a circulator for example), and any other power-consuming elements provided. In an exemplary embodiment, the electrical power line 58 includes two wires 60 and 62 that carry a single voltage and that are electrically coupled to a DC power converter 64 at the RAU 14. The DC power converter 64 is electrically coupled to the O/E converter 30 and the E/O converter 34 in the converter pair 48, and changes the voltage or levels of the electrical power signal 56 to the power level(s) required by the power-consuming components in the RAU 14. In an exemplary embodiment, the DC power converter 64 is either a DC/DC power converter or an AC/DC power converter, depending on the type of electrical power signal 56 carried by the electrical power line 58. In another example embodiment, the electrical power line 58 (dashed line) runs directly from the power supply 54 to the RAU 14 rather than from or through the HEU 12. In another example embodiment, the electrical power line 58 includes more than two wires and carries multiple voltages. Note that alternatively, electrical power lines to provide power to the RAU 14 could be fed through cable carrying the optical fibers 16D and/or 16U without being fed through the HEU 12 and other components or cables. Further, a power supply could be provided locally at the RAU 14.

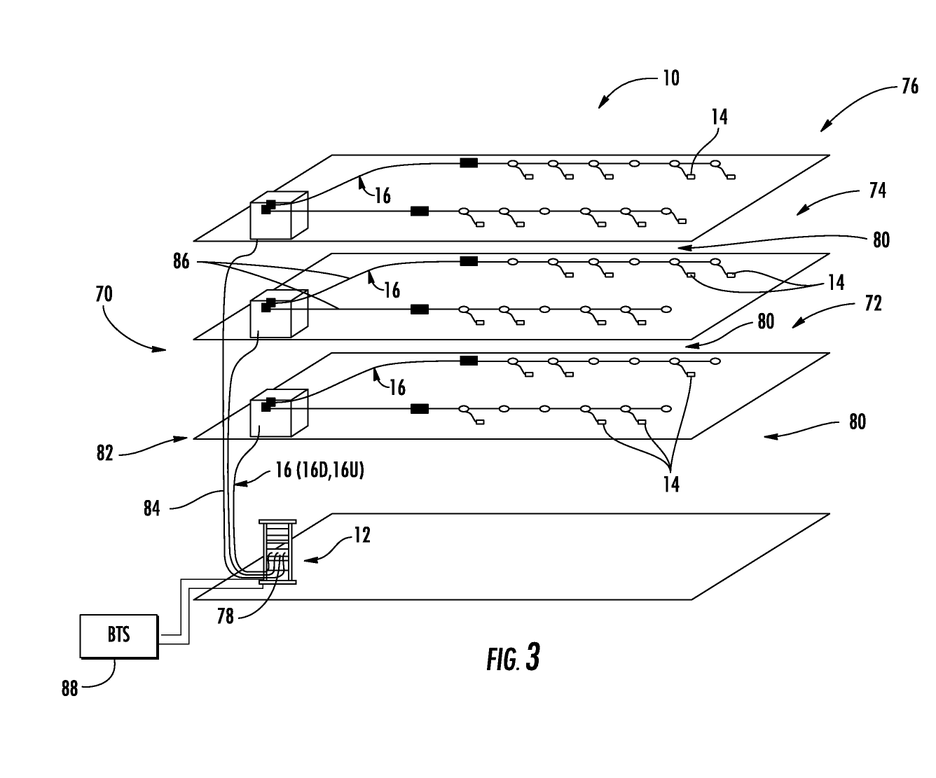

To provide further exemplary illustration of how an optical fiber-based distributed communications system can be deployed indoors, FIG. 3 is provided. FIG. 3 is a partially schematic cut-away diagram of a building infrastructure 70 employing an optical fiber-based distributed communications system. The system may be the optical fiber-based distributed communications system 10 of FIGS. 1 and 2. The building infrastructure 70 generally represents any type of building in which the optical fiber-based distributed communications system 10 can be deployed. As previously discussed with regard to FIGS. 1 and 2, the optical fiber-based distributed communications system 10 incorporates the HEU 12 to provide various types of communication services to coverage areas within the building infrastructure 70, as an example. For example, as discussed in more detail below, the optical fiber-based distributed communications system 10 in this embodiment is configured to receive wireless RF signals and convert the RF signals into RoF signals to be communicated over the optical fiber 16 to multiple RAUs 14. The optical fiber-based distributed communications system 10 in this embodiment can be, for example, an indoor distributed antenna system (IDAS) to provide wireless service inside the building infrastructure 70. These wireless signals can include cellular service, wireless services such as RFID tracking, Wireless Fidelity (WiFi), local area network (LAN), WLAN, and combinations thereof, as examples.

With continuing reference to FIG. 3, the building infrastructure 70 in this embodiment includes a first (ground) floor 72, a second floor 74, and a third floor 76. The floors 72, 74, 76 are serviced by the HEU 12 through a main distribution frame 78 to provide antenna coverage areas 80 in the building infrastructure 70. Only the ceilings of the floors 72, 74, 76 are shown in FIG. 3 for simplicity of illustration. In the example embodiment, a main cable 82 has a number of different sections that facilitate the placement of a large number of RAUs 14 in the building infrastructure 70. Each RAU 14 in turn services its own coverage area in the antenna coverage areas 80. The main cable 82 can include, for example, a riser section 84 that carries all of the downlink and uplink optical fibers 16D, 16U to and from the HEU 12. The main cable 82 can include one or more multi-cable (MC) connectors adapted to connect select downlink and uplink optical fibers 16D, 16U, along with an electrical power line (if provided), to a number of optical fiber cables 86.

The main cable 82 enables multiple optical fiber cables 86 to be distributed throughout the building infrastructure 70 (e.g., fixed to the ceilings or other support surfaces of each floor 72, 74, 76) to provide the antenna coverage areas 80 for the first, second and third floors 72, 74 and 76. In an example embodiment, the HEU 12 is located within the building infrastructure 70 (e.g., in a closet or control room), while in another example embodiment the HEU 12 may be located outside of the building infrastructure 70 at a remote location. A base transceiver station (BTS) 88, which may be provided by a second party such as a cellular service provider, is connected to the HEU 12, and can be co-located or located remotely from the HEU 12. A BTS is any station or source that provides an input signal to the HEU 12 and can receive a return signal from the HEU 12. In a typical cellular system, for example, a plurality of BTSs are deployed at a plurality of remote locations to provide wireless telephone coverage. Each BTS serves a corresponding cell and when a mobile station enters the cell, the BTS communicates with the mobile station. Each BTS can include at least one radio transceiver for enabling communication with one or more subscriber units operating within the associated cell.

The optical fiber-based distributed communications system 10 in FIGS. 1-3 and described above provides point-to-point communications between the HEU 12 and the RAU 14. Each RAU 14 communicates with the HEU 12 over a distinct downlink and uplink optical fiber pair to provide the point-to-point communications. Whenever an RAU 14 is installed in the optical fiber-based distributed communications system 10, the RAU 14 is connected to a distinct downlink and uplink optical fiber pair connected to the HEU 12. The downlink and uplink optical fibers may be provided in the optical fiber 16. Multiple downlink and uplink optical fiber pairs can be provided in a fiber optic cable to service multiple RAUs 14 from a common fiber optic cable. For example, with reference to FIG. 3, RAUs 14 installed on a given floor 72, 74, or 76 may be serviced from the same optical fiber cable. In this regard, a fiber optic cable carrying optical fiber 16 may have multiple nodes where distinct downlink and uplink optical fiber pairs can be connected to a given RAU 14.

It may be desirable to add RAUs in the optical fiber-based distributed communications system 10 to provide additional antenna coverage areas. For example, it may be desired to be able to upgrade the optical fiber-based distributed communications system 10 by providing additional antenna coverage areas depending on increased demand for capacity and location of client devices. To install a new RAU, an available unused downlink and uplink optical fiber pair must be provided and connected between the RAU and an HEU. For RAUs installed during initial installation of an optical fiber-based distributed communications system, provisions can be made to provide a downlink and uplink optical fiber pair to support the RAUs. However, to add RAUs after initial installation, provisions must be made to provide additional downlink and uplink optical fiber pairs. Additional downlink and uplink optical fiber pairs can be installed during initial installation and left unconnected or “dark” to allow for future upgrades. However, this increases initial cost by running additional “dark” optical fibers that will be initially unused. Further, the “dark” optical fibers may never be used thus never providing a return on their initial cost. Alternatively, instead of installing “dark” optical fibers, additional optical fibers can be installed when additional RAUs 14 are added. However, installing additional optical fibers after initial installation may be more costly than if the additional optical fibers were installed initially and left “dark.” Further, installing optical fibers when upgrades are desired can delay the upgrade.

In this regard, embodiments are disclosed herein to provide WDM in an optical fiber-based distributed communications system to allow for enhanced upgradability of antenna coverage areas. By providing WDM, multiple optical RF signals can be communicated between an HEU and RAUs at different wavelengths, also referenced as channels, over a common optical fiber, as opposed to providing a dedicated point-to-point connection optical fiber between the HEU and each RAU. Each wavelength produced by WDM is communicated over a common optical fiber. Each wavelength is then dropped to the destined component in the optical fiber-based distributed communications system based on wavelength filtering. Other wavelengths can travel essentially undisrupted over the common optical fiber to other components connected to the common optical fiber. In this manner, when RAUs are added to the optical fiber-based distributed communications system, use of previously installed “dark” optical fibers or new installation of optical fibers is not required. The additional RAUs can be connected to the end of an existing optical fiber in a daisy-chain configuration and configured to filter the wavelength of choice

In this regard, certain embodiments disclosed herein provide for WDM on a downlink optical fiber in an optical fiber-based distributed communications system. Multiple downlink optical RF signals, each destined for a particular RAU, can be wavelength division multiplexed at unique wavelengths over a common downlink optical fiber to service multiple RAUs from the common downlink optical fiber. A wavelength filter is provided in each RAU to allow receipt of optical RF signals at a desired wavelength and to allow the other wavelengths to continue to travel over the downlink optical fiber undisrupted to other RAUs. In this manner, when it is desired to add RAUs to the optical fiber-based distributed communications system, use of previously installed “dark” downlink optical fibers or new installation of downlink optical fibers is not required. The additional RAUs can be connected to the end of an existing downlink optical fiber in a daisy-chain configuration without providing additional or new downlink optical fibers. The added RAUs are equipped with wavelength filters compatible with channels in a wavelength division multiplexer. An additional laser(s) can be added to provide a unique wavelength compatible with the wavelength filter of the added RAU, if needed, to allow new RAU(s) to be connected to the common downlink optical fiber.

In this regard, FIG. 4 is a schematic diagram of employing wavelength division multiplexing (WDM) in an exemplary downlink optical fiber 90 in an exemplary optical-fiber based distributed communication system. WDM in this embodiment allows additional RAUs to be supported from a common optical fiber in a daisy-chain configuration. Such an optical fiber-based distributed communications system can be the optical fiber-based distributed communications system 10 in FIGS. 1-3, as an example. As illustrated in FIG. 4, the single, common downlink optical fiber 90 is provided with multiple branch points or nodes 92. The nodes 92 provide for the ability of RAUs 94 to be connected to the downlink optical fiber 90 at a given location along the downlink optical fiber 90. The RAUs 94 provide antenna coverage areas. The RAUs 94 may be the RAU 14 illustrated in FIGS. 1-3, as an example. In this example, the downlink optical fiber 90 is provided in a fiber optic cable 93 that can be routed in a building or other infrastructure, such as the building infrastructure 70 in FIG. 3 as an example.

With continuing reference to FIG. 4, a wavelength division multiplexer 96 is provided in this embodiment. The wavelength division multiplexer 96 is configured to multiplex multiple received optical RF signals 98 on different wavelengths or channels onto the downlink optical fiber 90. The optical RF signals 98 could be analog or digital optical RF signals as examples. The downlink optical fiber 90 may be the only downlink optical fiber provided in an optical fiber-based distributed communications system, or it may be one of a number of different downlink optical fibers each capable of supporting multiple RAUs 94. For example, the downlink optical fiber 90 may be distributed on one floor of a building.

Each RAU 94 connected to a node 92 includes an optical wavelength filter 102 configured to allow the desired optical wavelength from multiplexed optical RF signals traveling on the downlink optical fiber 90. In this manner, each RAU 94 can be configured to receive one of the wavelengths from the multiplexed optical RF signals corresponding to one of the multiple optical RF signals 98. Other wavelengths are allowed to continue to travel down the downlink optical fiber 90 to other RAUs 94 undisrupted, thereby allowing the common downlink optical fiber 90 to service multiple RAUs 94. This is opposed to a requirement to provide separate downlink optical fibers for each RAU 94.

For example, the optical wavelength filter 102 may be a thin film filter (TFF) device that transmits one wavelength to the RAU 94 and reflects the remaining wavelengths on the downlink optical fiber 90 to the next node 92 connected to a RAU 94. Additional RAUs 94′ can be added to additional nodes 92′ on the downlink optical fiber 90 in a daisy-chain configuration, as illustrated in FIG. 4, without a new downlink optical fiber being provided. Another extension optical fiber(s) 100 is used to connect an additional RAU(s) 94′ to the existing downlink optical fiber 90, as illustrated in FIG. 4. For example, the extension optical fiber(s) 100 may be spliced to the existing downlink optical fiber 90. The existing RAUs 94 and existing downlink optical fiber 90 would be otherwise unaffected by the addition of a new RAU(s) 94′.

The capacity to add new RAUs to the downlink optical fiber 90 is only limited by the channel capacity of the wavelength division multiplexer 96. If the wavelength division multiplexer 96 does not support multiplexing a number of channels that is the same or greater than the number of RAUs 94, 94′ connected to the downlink optical fiber 90, the wavelength division multiplexer 96 can be updated to provide increased channel multiplexing capacity. For example, if the wavelength division multiplexer 96 supports multiplexing eight (8) channels, the wavelength division multiplexer 96 can support the downlink optical fiber connected to up to eight (8) RAUs 94. If, for example, sixteen (16) RAUs are desired be supported by the downlink optical fiber 90, the wavelength division multiplexer 96 in this example would need to be upgraded to provide for a multiplexing capacity of at least sixteen (16) channels. However, a new downlink optical fiber is not required other than the extension optical fiber(s) 100 to connect an additional RAU(s) 94′ to the existing downlink optical fiber 90.

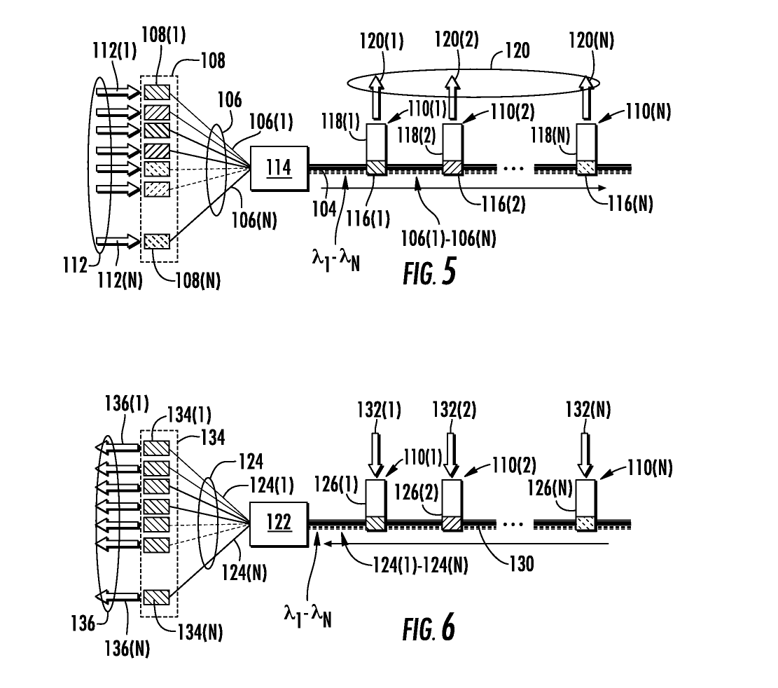

To further explain providing WDM on a communication downlink, FIG. 5 is also provided that includes optical subassemblies (OSAs). FIG. 5 is a schematic diagram of an exemplary common downlink optical fiber 104 that can be provided in an optical fiber-based distributed communications system. WDM is employed to multiplex a plurality of downlink optical RF signals 106(1)-106(N) from a plurality of transmit optical subassemblies (TOSAs) 108(1)-108(N). The plurality of downlink optical RF signals 106(1)-106(N) are communicated over the common downlink optical fiber 104 to be communicated to a plurality of RAUs 110(1)-110(N). TOSAs provide electrical RF signal to optical RF signal conversion. The (1)-(N) notation indicates that any number of TOSAs 108 can be used. The TOSAs 108(1)-108(N) in this embodiment each include modulators to modulate a light wave, such as a light emitted by a laser, to produce the downlink optical RF signals 106(1)-106(N) modulated at the frequency of downlink electrical RF signals 112(1)-112(N). The optical wavelength used for modulation for a given TOSA 108 may be specified by the fixed wavelength of the laser provided in the TOSA 108. Alternatively, the laser provided in the TOSA 108 may be tunable to provide an adjustable and/or programmable optical wavelength. RAU 110(N) signifies an RAU added to the common downlink optical fiber 104 after initial installation in a daisy-chain configuration.

The downlink electrical RF signals 112(1)-112(N) are received and converted into downlink optical RF signals 106(1)-106(N) by the TOSAs 108(1)-108(N) as inputs into a wavelength division multiplexer 114. The wavelength division multiplexer 114 multiplexes the different downlink optical RF signals 106(1)-106(N) into different channels or wavelengths λ₁-λ_{N} and communicates the multiplexed downlink optical RF signals 106(1)-106(N) over the common downlink optical fiber 104. Each RAU 110(1)-110(N) includes a wavelength filter 116(1)-116(B), such as those previously described with regard to FIG. 4, to receive downlink optical RF signals 106(1)-106(N) at the designed wavelength for the RAU 110(1)-110(N). The filtered downlink optical RF signals 106(1)-106(N) at each RAU 110(1)-110(N) are received by receiver optical subassemblies (ROSAs) 118(1)-118(N) to convert the filtered downlink optical RF signals 106(1)-106(N) from optical RF signals to electrical RF signals 120(1)-120(N) to provide respective antenna coverage areas.

In this embodiment, because the WDM 114 combines downlink optical RF signals 106(1)-106(N) individually at different wavelengths, and the RAUs 110(1)-110(N) include wavelength filters 116(1)-116(N) to uniquely receive a given wavelength, different services can be provided to different RAUs 110(1)-110(N). For example, if cellular services are provided, certain RAUs 110 could receive Global System for Mobile Communications (GSM) cellular signals, and other RAUs could receive Code Division Multiple Access (CDMA) cellular signals. In this example, some TOSAs 108 could be configured to provide GSM modulation and others configured to provide CDMA modulation. As another example, a localization or tracking signal could be provided to certain RAUs 110 to provide tracking RAUs that can provide localization services for client devices. Examples of providing localization services in an optical fiber-based distributed communications system are described in U.S. Provisional Patent Application No. 61/319,659 filed on Mar. 31, 2010, and entitled “Localization Services in Optical Fiber-based Distributed Communications Components and Systems, and Related Methods,” incorporated herein by reference in its entirety.

WDM can also be provided for an uplink optical fiber provided in an optical fiber-based distributed communications system. Providing WDM for an uplink optical fiber can avoid providing additional uplink optical fibers when adding RAUs in a similar manner as described above for a downlink optical fiber and illustrated in FIGS. 4 and 5, as an example. In this regard, FIG. 6 is a schematic diagram of employing a wavelength division de-multiplexer 122. The wavelength division de-multiplexer 122 de-multiplexes a plurality of uplink optical RF signals 124(1)-124(N) at a plurality of different wavelengths λ₁-λ_{N} that were originally provided by a plurality of transmit optical subassemblies (TOSAs) 126(1)-126(N) provided in RAUs 110(1)-110(N) connected to a common uplink optical fiber 130 and wavelength-division multiplexed into wavelengths λ₁-λ_{N}. Each RAU 110(1)-110(N) includes a wavelength filter to add uplink optical RF signals 124(1)-124(N) at the designed wavelength for the RAU 110(1)-110(N) to a common uplink optical fiber 130. The wavelength division de-multiplexer 122 provided in FIG. 6 could be combined with providing WDM in FIG. 5. The wavelength division de-multiplexer 122 could be provided together with the wavelength division multiplexer 114 as one component or housing employing WDM and WDD. The wavelength division multiplexer 114 and wavelength division de-multiplexer 122 could be realized, for example, as integrated devices integrating laser chips and/or photodiode chips with filtering elements in a combined packaging. As another example, Silicon-photonics could be used as technology for integrated modulators and electronics, such as in C-type metal oxide semiconductor (CMOS) circuits.

The TOSAs 126(1)-126(N) provided in the RAUs 110(1)-110(N) receive and convert incoming electrical RF signals 132(1)-132(N) into the uplink optical RF signals 124(1)-124(N). Wavelength-division multiplexing of the uplink optical RF signals 124(1)-124(N) could be provided by each TOSA 126(1)-126(N) being assigned a different optical wavelength to transmit the uplink optical RF signals 124(1)-124(N) on the common uplink optical fiber 130. The optical wavelength used for modulation for a given TOSA 126 may be specified by the fixed wavelength of the laser provided in the TOSA 126. Alternatively, the laser provided in the TOSA 126 may be tunable to provide an adjustable and/or programmable optical wavelength for modulation. The RAUs 110(1)-110(N) may be the same RAUs 110(1)-110(N) provided in FIG. 5. The uplink optical RF signals 124(1)-124(N) are provided over the common uplink optical fiber 130 to the wavelength division multiplexer 122. The wavelength division multiplexer 122 then de-multiplexes the uplink optical RF signals 124(1)-124(N) into individual uplink optical RF signals 124 at each of the wavelengths λ₁-λ_{N} to provide such signals to ROSAs 134(1)-134(N). The ROSAs 134(1)-134(N) each detect and convert an individual uplink optical RF signal 124 received into the ROSAs 134(1)-134(N) into an individual electrical RF signal 136(1)-136(N). The electrical RF signals 136(1)-136(N) can then to be provided over a network or to client devices directly or via a network.

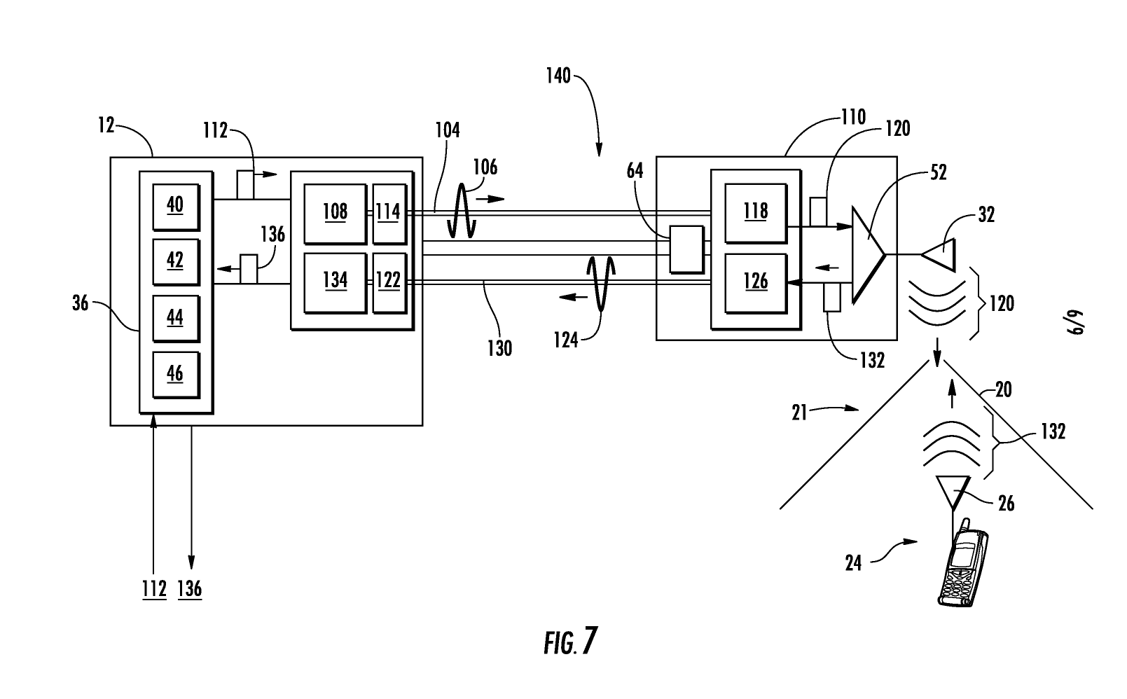

FIG. 7 illustrates providing WDM for a downlink optical fiber in FIG. 5 and providing WDD for an uplink in FIG. 6 in an optical fiber-based wireless communications system 140. The optical fiber-based wireless communications system 140 may include similar components to the optical fiber-based wireless communications system 10 illustrated in FIG. 2. Common components between FIG. 2 and FIG. 7 are illustrated with common element numbers and will not be re-described. The components previously described in FIGS. 5 and 6 are provided in FIG. 7 and thus will not be re-described. FIG. 7 only illustrates one RAU 110. But it should be noted that multiple RAUs 110 can be provided in FIG. 7, where multiple optical RF signals are communicated by the multiple RAUs 110 to and from the HEU 12 over the common downlink optical fiber 104 and the common uplink optical fiber 130.

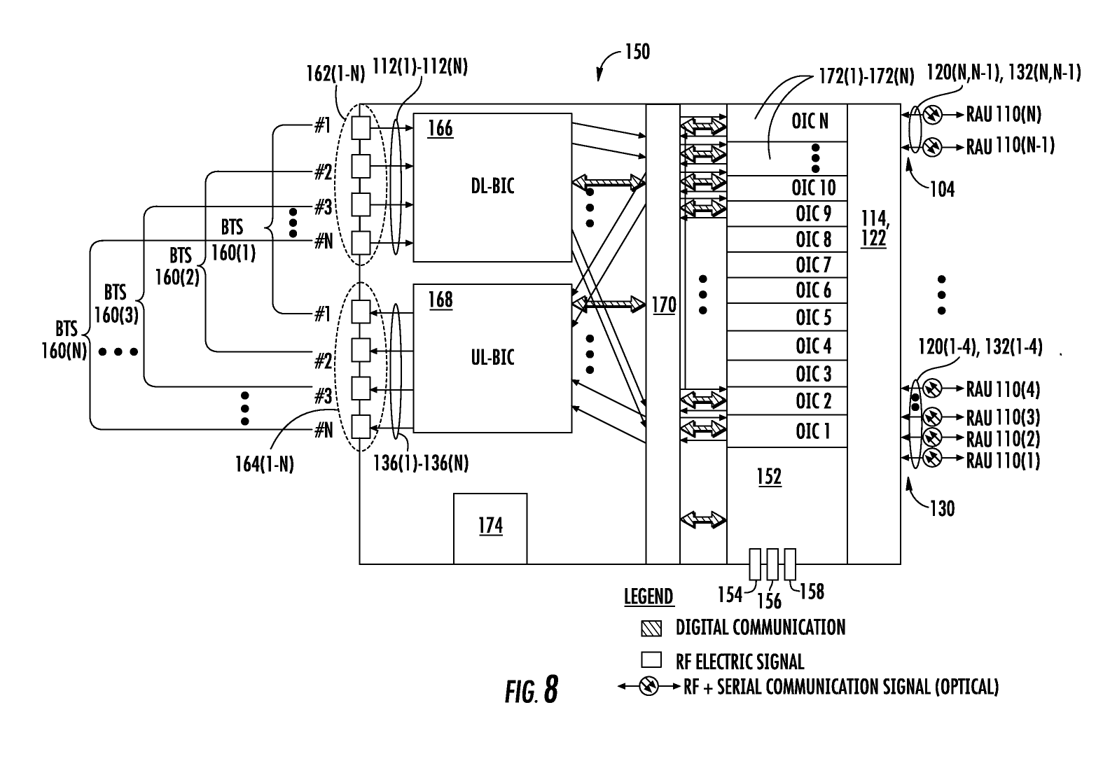

FIG. 8 is a schematic diagram of another exemplary HEU 150 that can employ WDM on a common downlink optical fiber and WDD on a common uplink optical fiber for the RAUs 110(1)-110(N) provided FIGS. 5 and 6, respectively. Common elements between FIGS. 5 and 6 are provided with the same element numbers in FIG. 8. As illustrated in FIG. 8, the HEU 150 in this embodiment includes a head-end controller (HEC) 152 that manages the functions of the HEU 150 components and communicates with external devices via interfaces, such as a RS-232 port 154, a Universal Serial Bus (USB) port 156, and an Ethernet port 158, as examples. The HEU 150 can be connected to a plurality of BTSs 160(1)-160(N), transceivers, and the like via BTS inputs 162(1)-162(N) and BTS outputs 164(1)-164(N). The BTS inputs 162(1)-162(N) are downlink connections and the BTS outputs 164(1)-164(N) are uplink connections. Each BTS input 162(1)-162(N) is connected to a downlink BTS interface card (BIC) 166 located in the HEU 150. Each BTS output 164(1)-164(N) is connected to an uplink BIC 168 also located in the HEU 150. The downlink BIC 166 is configured to receive the incoming or downlink electrical RF signals 112(1)-112(N) from the BTS inputs 162(1)-162(N) and split the downlink electrical RF signals 112(1)-112(N) into copies to be communicated to the RAUs 110(1)-110(N), as illustrated in FIG. 8. The uplink BIC 168 is configured to receive the combined outgoing or uplink electrical RF signals 136(1)-136(N) from the RAUs 110(1)-110(N) and split the uplink electrical RF signals 136(1)-136(N) into individual BTS outputs 164(1)-164(N) as a return communication path.

The downlink BIC 166 is connected to a midplane interface 170 in this embodiment. The uplink BIC 168 is also connected to the midplane interface 170. The downlink BIC 166 and uplink BIC 168 can be provided in printed circuit boards (PCBs) that include connectors that can plug directly into the midplane interface 170. The midplane interface 170 is in electrical communication with a plurality of optical interface cards (OICs) 172(1)-172(N), which provide an optical to electrical communication interface and vice versa between the RAUs 110(1)-110(N) via the common downlink optical fiber 104 and common uplink optical fiber 130 and the downlink BIC 166 and uplink BIC 168. The OICs 172(1)-172(N) include the TOSAs 108(1)-108(N) and ROSAs 134(1)-134(N), as illustrated in FIGS. 5 and 6. The wavelength division multiplexer 114 and wavelength division de-multiplexer 122 of FIGS. 5 and 6 are provided between the TOSAs 108(1)-108(N) and ROSAs 134(1)-134(N) and the OICs 172(1)-172(N), respectively, to allow the common downlink optical fiber 104 and common uplink optical fiber 130 to be provided to the RAUs 110(1)-110(N) and to allow additional RAUs 110 to be added in a daisy-chain configuration, as previously described.

The OICs 172(1)-172(N) in this embodiment support up to three (3) RAUs 110 each. The OICs 172(1)-172(N) can also be provided in a PCB that includes a connector that can plug directly into the midplane interface 170 to couple the links in the OICs 172(1)-172(N) to the midplane interface 170. Multiple OICs 172(1)-172(N) may be packaged together to form an optical interface module (OIM). In this manner, the HEU 150 is scalable to support up to thirty-six (36) RAUs 110 in this embodiment since the HEU 150 can support up to twelve (12) OICs 172. If less than thirty-six (36) RAUs 110 are to be supported by the HEU 150, less than twelve (12) OICs 172 can be included in the HEU 150 and plugged into the midplane interface 170. One OIC 172 is provided for every three (3) RAUs 110 supported by the HEU 150 in this embodiment. OICs 172 can also be added to the HEU 150 and connected to the midplane interface 170 if additional RAUs 110 are desired to be supported beyond an initial configuration. A head-end unit (HEU) controller 174 can also be provided that is configured to be able to communicate with the downlink BIC 166, the uplink BIC 168, and the OICs 172(1)-172(N) to provide various functions, including configurations of amplifiers and attenuators provided therein.

The embodiments discussed in regard to FIGS. 5 and 7 allow individual communication signals to be directed over a common downlink optical fiber to individual RAUs. In this manner, different services can be provided at different RAUs. For example, different signal types or services (e.g., different cellular signals, e.g., GSM and CDMA) can be provided to different RAUs. However for certain applications, it may be desirable or useful to broadcast the same communication signal from the downlink BIC 166 in FIG. 8 to all RAUs 110. In this instance, lasers in the TOSAs 108 would not necessarily have to modulate their downlink electrical RF signals 112 individually. All downlink optical RF signals 106 produced by the TOSAs 108 could be modulated simultaneously after being wavelength division multiplexed by the wavelength division multiplexer 114 by employing an external modulator. Thus, individual modulators provided for lasers in the individual TOSAs 108 could be eliminated and cost savings realized by providing modulation electronics in a single instance on the output of the wavelength division multiplexer 114. The TOSAs 108 could be provided to avoid costly bandwidth requirements modulating the drive current of the laser in the TOSAs 108.

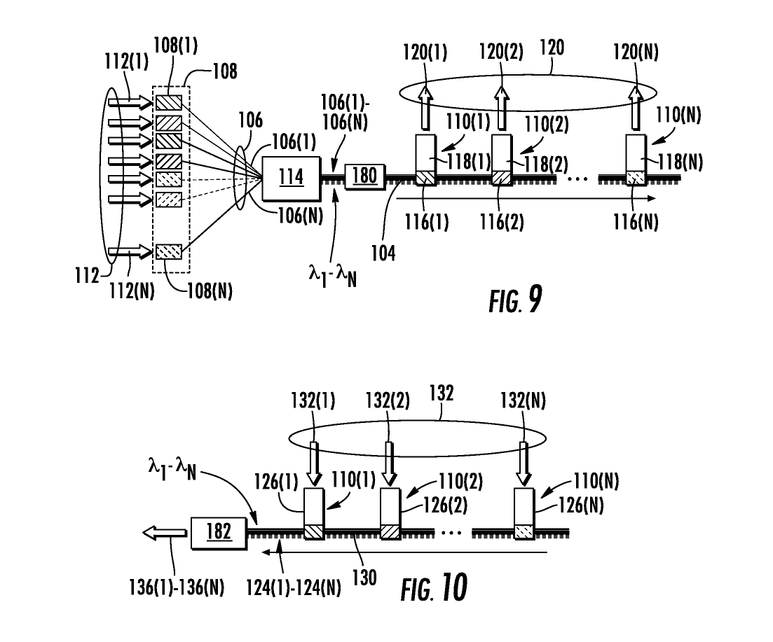

In this regard, FIG. 9 is a schematic diagram of FIG. 5, but alternatively employing a common modulator on the common downlink optical fiber 104 in lieu of providing modulators disposed in individual downlink TOSAs. With reference to FIG. 9, a common modulator 180 is employed on the common downlink optical fiber 104 to receive the downlink optical RF signal 106 after being wavelength division multiplexed by the wavelength division multiplexer 114. The common modulator 180 simultaneously modulates the downlink optical RF signal 106 at the different wavelengths or channels λ₁-λ_{N} provided by the WDM 114. As a result, modulation electronics can be provided once in the common modulator 180 for the common downlink optical fiber 104 instead of having to provide individual modulators in the TOSAs 108(1)-108(N), thus saving cost. Further, the TOSAs 108(1)-108(N) would not include modulation bandwidth requirements in this instance. As an example, the common modulator 180 may be a Mach-Zehnder interferometric (MZI)-based modulator. Alternatively, an electroabsorption modulator (EAM) with suitable linearity may be employed. As previously discussed, the RAUs 110(1)-110(N) include wavelength filters 116(1)-116(N) to receive one of the downlink optical RF signals 106(1)-106(N) multiplexed by the wavelength division multiplexer 114 at a given wavelength.

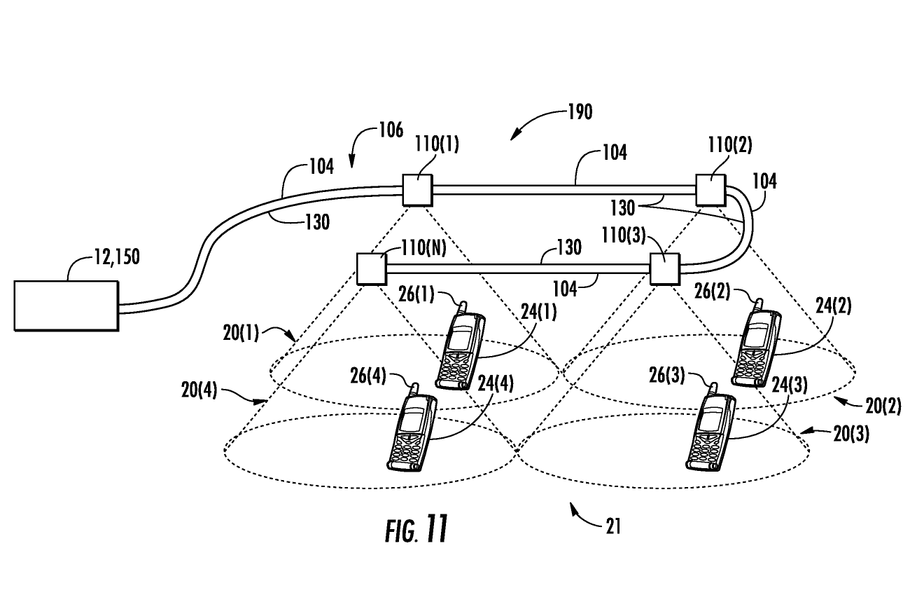

FIG. 10 is a schematic diagram of FIG. 6, but alternatively employing a common ROSA 182 on the common uplink optical fiber 130 in lieu of providing individual ROSAs 134 for each wavelength, as illustrated in FIG. 6 and previously described. This configuration may be advantageous if the uplink optical RF signals 124(1)-124(N) are not required to be converted into different frequencies when the uplink optical RF signals 124(1)-124(N) are converted into electrical RF signals 136(1)-136(N). In this instance, the combined uplink optical RF signals 124(1)-124(N) can be received and converted to an electrical RF signal 136 with one common ROSA 182 as opposed to providing individual ROSAs 134 for each wavelength.

Note that in the above-described embodiments, WDM employed for a downlink optical fiber in FIG. 5 and WDD employed for an uplink optical fiber in FIG. 6 are described as being able to be provided in the same optical fiber-based distributed communications system. WDM and a common modulator employed for a downlink optical fiber in FIG. 9 and a common ROSA for an uplink optical fiber in FIG. 10 are described as being able to be provided in the same optical fiber-based distributed communications system. However, note any of these possibilities can be provided individually in any combination with one another. Any of the embodiments in FIGS. 5-10 can be provided individually without providing other embodiments disclosed therein. For example, the optical fiber downlink embodiment in FIG. 5 can be employed with the uplink optical fiber embodiment in FIG. 10. For example, the optical fiber downlink embodiment in FIG. 9 can be employed with the uplink optical fiber embodiment in FIG. 6.

Numerous variations and applications of the embodiments disclosed herein can be provided. As one example, the embodiments disclosed herein can be used to provide a Multiple Input, Multiple Output (MIMO) communication system 190, as illustrated in FIG. 11. As illustrated therein, a 4×4 MIMO system may be provided, shown by the four (4) RAUs 110(1), 110(2), 110(3), and 110(4) grouped together. In this example, four wavelengths or channels from the WDM (e.g., the wavelength division multiplexer 114 in FIG. 5) provided on the common uplink optical fiber 130 could be grouped together to transmit the same downlink optical RF signal 106 on the common uplink optical fiber 130 to the RAUs 110(1), 110(2), 110(3), and 110(4). The MIMO communication system 190 may also include dynamic cell bonding (DCB) as described in examples provided in co-pending U.S. patent application Ser. No. 12/705,779 filed Feb. 15, 2010, entitled “Dynamic Cell Bonding (DCB) For Radio-over-Fiber (RoF)-Based Networks and Communication Systems and Related Methods,” which is incorporated herein by reference in its entirety. Other numbers of groupings are possible.

Note that optical amplification could also be employed in the downlink and/or uplink optical fiber to reduce optical loss and/or reduce noise. For example, optical amplification could be provided using Erbium-Doped Fiber Amplifiers (EDFAs), or Semiconductor Optical Amplifiers (SOAs). Several wavelengths would also be amplified simultaneously by placing an amplifier in a part of the system where all or at least multiple wavelengths are transmitted on a common downlink optical fiber and/or common uplink optical fiber. Alternatively, wavelengths could be amplified individually by placing amplifiers in a region of the system where only one wavelength is transmitted on a particular optical fiber. Optical amplification could be integrated with the TOSA(s) and/or ROSA(s).

Further, instead of employing single wavelength lasers in a TOSA, an injection locked Fabry-Perot (FP) laser, a Reflective SOA (R-SOA), or an electroabsorption modulator (EAM) could be used as a transmit element in the TOSA. In order to define the desired transmit wavelength, a seed signal would be launched from the central location to a remote transmitter. This could be accomplished, for example, by using a broadband source (super luminescent LED (SLED) or amplified spontaneous emission (ASE) source) and spectral slicing at the WDM.

As additional alternatives, Coarse Wavelength Division Multiplexing (CWDM) could be employed. CWDM may employ a typical channel spacing of twenty (20) nanometers (nm) as an example. Alternatively, Dense Wavelength Division Multiplexing (DWDM) could be employed. DWDM may employ a channel spacing of 200 GigaHertz (GHz), 100 GHz, or 50 GHz, as examples, depending on the detailed requirements. The number of channels in CWDM may be limited and simultaneous optical amplification of all channels may be difficult, but costs may be lowered as a result.

Further, instead of dropping/adding of only one channel per node or RAU, a tree structure is also possible. In this case, at each node, more than one wavelength channel would be dropped/added. Therefore, more than one RAU would be served from each node with an individual fiber pair running from the node to the antenna of the RAU. As another possibility, the uplink optical RF signals and downlink optical RF signals could be provided on a common optical fiber that carries both uplink and downlink signals. In this case, the downlink optical RF signals may be carried on a first wavelength group (e.g., λ₁-λ_{N}) and the uplink optical RF signals may be carried on a second wavelength group (e.g., λ_{N+1}-λ_{M}). In this regard, for example, the downlink optical fiber 104 in FIG. 5 and the uplink optical fiber 130 in FIG. 6 could be replaced with a single optical fiber that carries both downlink optical RF signals 106(1)-106(N) and uplink optical RF signals 124(1)-124(N) over the common optical fiber.

Further, as used herein, it is intended that terms “fiber optic cables” and/or “optical fibers” include all types of single mode and multi-mode light waveguides, including one or more optical fibers that may be upcoated, colored, buffered, ribbonized and/or have other organizing or protective structure in a cable such as one or more tubes, strength members, jackets or the like. Likewise, other types of suitable optical fibers include bend-insensitive optical fibers, or any other expedient of a medium for transmitting light signals. An example of a bend-insensitive, or bend resistant, optical fiber is ClearCurve® Multimode fiber commercially available from Corning Incorporated. Suitable fibers of this type are disclosed, for example, in U.S. patent application Publication Nos. 2008/0166094 and 2009/0169163, the disclosures of which are incorporated herein by reference in their entireties. ClearCurve® Singlemode fiber available from Corning Incorporated may also be employed.

Many modifications and other embodiments of the embodiments set forth herein will come to mind to one skilled in the art to which the embodiments pertain having the benefit of the teachings presented in the foregoing descriptions and the associated drawings. These modifications include, but are not limited to, whether a tracking signal is provided, whether downlink and/or uplink BICs are included, whether tracking signal inputs are provided in the same distributed communications unit as downlink BTS inputs, the number and type of OICs and RAUs provided in the distributed communications system, etc. Therefore, it is to be understood that the description and claims are not to be limited to the specific embodiments disclosed and that modifications and other embodiments are intended to be included within the scope of the appended claims. It is intended that the embodiments cover the modifications and variations of the embodiments provided they come within the scope of the appended claims and their equivalents. Although specific terms are employed herein, they are used in a generic and descriptive sense only and not for purposes of limitation.

What is claimed is:

1. An optical fiber-based distributed communications system, comprising:
a plurality of downlink optical transmitters configured to receive downlink electrical radio frequency (RF) signals from a plurality of RF sources and convert the downlink electrical RF signals into downlink optical RF signals; and
a wavelength division multiplexer configured to multiplex the downlink optical RF signals into a plurality of downlink wavelengths over a common downlink optical fiber configured to be connected to a plurality of remote antenna units (RAUs).

2. The system of claim 1, further comprising the plurality of remote antenna units (RAUs) connected to the common downlink optical fiber and each including a wavelength filter configured to filter at least one of downlink wavelength among the plurality of downlink wavelengths of the downlink optical RF signals on the common downlink optical fiber.

3. The system of claim 2, wherein the plurality of RAUs are not connected to other downlink optical fibers other than the common downlink optical fiber.

4. The system of claim 2, further comprising a plurality of downlink optical receivers disposed in the plurality of RAUs each configured to receive the downlink optical RF signals at the at least one downlink wavelength.

5. The system of claim 2, further comprising an additional RAU connected to an end of the common downlink optical fiber opposite from an end of the common downlink optical fiber connected to the wavelength division multiplexer.

6. The system of claim 2, wherein the plurality of RAUs are connected to the common downlink optical fiber in a daisy-chain configuration.

7. The system of claim 1, wherein the downlink optical RF signals are comprised of digital downlink optical RF signals.

8. The system of claim 1, further comprising a wavelength division de-multiplexer configured to:
receive uplink optical RF signals from the plurality of RAUs on a common uplink optical fiber; and
de-multiplex a plurality of uplink wavelengths from the uplink optical RF signals into separate uplink wavelengths among the plurality of uplink wavelengths.

9. The system of claim 8, further comprising a plurality of uplink optical receivers each configured to receive the uplink optical RF signals at an uplink wavelength among the plurality of uplink wavelengths.

10. The system of claim 8, wherein the uplink optical RF signals are comprised of digital downlink optical RF signals.

11. The system of claim 2, further comprising a common uplink optical fiber connected to each of the plurality of RAUs; and
a plurality of uplink optical transmitters disposed in the plurality of RAUs configured to transmit uplink optical RF signals at a plurality of uplink wavelengths on the common uplink optical fiber.

12. The system of claim 1, further comprising a common modulator configured to modulate the plurality of downlink wavelengths from the wavelength division multiplexer simultaneously on the common downlink optical fiber.

13. The system of claim 1, wherein the plurality of downlink optical transmitters do not include modulators.

14. The system of claim 8, further comprising a common optical receiver configured to detect and convert the plurality of uplink wavelengths of the uplink optical RF signals simultaneously on the common uplink optical fiber into uplink electrical RF signals.

15. The system of claim 14, further comprising not providing a wavelength division de-multiplexer to de-multiplex the plurality of uplink wavelengths in the uplink optical RF signals.

16. The system of claim 14, further comprising not providing individual optical receivers to receive and convert the uplink optical RF signals into uplink electrical RF signals.

17. The system of claim 1, wherein at least two RAUs connected to the common downlink optical fiber are configured to provide a Multiple In/Multiple Out (MIMO) communication signal.

18. A method of distributing communication signals in an optical fiber-based distributed communications system, comprising:
receiving downlink electrical radio frequency (RF) signals from a plurality of RF sources;
converting the downlink electrical RF signals into downlink optical RF signals; and
wavelength division multiplexing the downlink optical RF signals into a plurality of downlink wavelengths over a common downlink optical fiber.

19. The method of claim 18, further comprising wavelength filtering a downlink wavelength among the plurality of downlink wavelengths in the downlink optical RF signals at each of a plurality of remote antenna units (RAUs) connected to the common downlink optical fiber.

20. The method of claim 18, further comprising not connecting the plurality of RAUs to other downlink optical fibers other than the common downlink optical fiber.

21. The method of claim 18, further comprising connecting an additional RAU to the common downlink optical fiber.

22. The method of claim 18, wherein the plurality of RAUs are connected to the common downlink optical fiber in a daisy-chain configuration.

23. The method of claim 18, further comprising wavelength division de-multiplexing a plurality of uplink wavelengths from uplink optical RF signals on a common uplink optical fiber into separate uplink wavelengths among the plurality of uplink wavelengths.

24. The method of claim 23, further comprising a plurality of uplink optical receivers each receiving the uplink optical RF signals at an uplink wavelength among the plurality of uplink wavelengths.

25. The method of claim 18, further comprising a plurality of RAUs each transmitting uplink optical RF signals at a plurality of uplink wavelengths on a common uplink optical fiber.

26. The method of claim 19, further comprising modulating the plurality of downlink wavelengths from a wavelength division multiplexer simultaneously in a common modulator on the common downlink optical fiber.

27. The method of claim 23, further comprising detecting and converting the plurality of uplink wavelengths of the uplink optical RF signals simultaneously on the common uplink optical fiber into uplink electrical RF signals.
